(19) United States
(12) Patent Application Publication
(10) Pub. No.: US 2007/0081678 A1
(43) Pub. Date: Apr. 12, 2007

(54) Video camera with integrated radio

(76) Inventor: Boyd Michael Minnich, Morristown, TN (US)

Correspondence Address: KNOX PATENTS, P.O. BOX 30034, KNOXVILLE, TN, 37930-0034, US

(21) Appl. No.: 11/247,643

(22) Filed: Oct. 11, 2005

(51) Int. Cl. H02B 1/00

(52) U.S. Cl. 381/123

(57) ABSTRACT

A video camera with an integral radio. The video camera records video images on a desired recording medium contemporaneously with an audio track from a selected audio source. Various audio sources including a microphone, a radio receiver, and a line-in auxiliary input are available. With multiple audio sources available, a secondary audio program, such as a radio broadcast, can be recorded to narrate the video action.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The invention relates to a video recording device. More specifically, this invention relates to a video recording device with an integrated radio.

2. Description of the Related Art

It is common to use a video camera to record and preserve an event. Conventional video cameras include an integral microphone for recording the ambient audio contemporaneous with the video. Certain types of events are self-narrating, such as a birthday party, where the audible action is generally as important as the visual action. Other types of events have associated audio components that are not necessary or even preferred in relation to the visual component and, as such, are not self-narrating.

An example of an event that is not self-narrating is a sporting event, such as a football game. There are many factors that determine whether the audio component is useful when recording a sporting event. Sporting events are typically recorded from a distance, such as on the sideline. Because of the distance, the actual audio associated with the event is often difficult to pick up clearly, if it can be heard at all. Compounding the problem are the sounds occurring proximate to the video camera. Where the event occurs at a distance, the audible sounds may have nothing to do with the event. For example, coughing or discussions about lunch detract from the event. Even if there are no competing sounds and the audible action from the event is clearly heard, the audible sounds may not add to the overall presentation. Often, the communication between athletes is minimalistic and is not particular useful for those not participating. To compensate, broadcast coverage of sporting events uses commentators that provide a running analysis of and/or a commentary on event being viewed. The commentators are typically removed from the details of visual recording so that they can view the event from a perspective conducive to analysis or commentary.

Unfortunately, when using a conventional video camera, the options for accessing a remote audio source are limited. Often, post-production editing is used to replace the ambient audio track with an audio track obtained from a secondary source. However, the mixing of pre-recorded video with pre-recorded or new audio typically requires additional equipment. Accordingly, it is desirable to produce a video camera that provides options for using a secondary audio source during the original video recording.

### BRIEF SUMMARY OF THE INVENTION

A video camera with an integral radio, or video camera, is shown and described. The video camera records video images on a desired recording medium contemporaneously with an audio track from a selected audio source. Various audio sources including a microphone, a radio receiver, and a line-in auxiliary input are available. With multiple audio sources available, a secondary audio program, such as a radio broadcast, can be recorded to narrate the video action.

The video section of the video camera includes a lens that allows light carrying an image into the video camera. The light is collected by an image detector that converts the light into a video signal. A video transfer mechanism takes the video signal and transfers it onto a storage medium for archival.

The audio section of the video camera incorporates multiple audio sources. A microphone is used to pick up ambient sounds. An optional auxiliary input provides an input for accepting a line level signal from a remote source, such as from a public address system. The video camera also includes a radio receiver for decoding radio frequency signals from a remote broadcast source. The radio frequency signals are received and transferred to the receiver through an antenna. A tuner cooperating with the receiver allows a particular radio frequency signal to be isolated for reception. A user interface communicating with the tuner includes a tuning selector that allows an operator to select a particular radio frequency or station for reception. In one embodiment, the tuning selector is implemented using buttons or a dial and digital display for the frequency. In another embodiment, tuning selector display is an analog display.

Each of the audio inputs, the microphone, the auxiliary input, and the radio receiver are routed through a switch. The switch controls which input is passed to an audio transfer mechanism. The audio transfer mechanism transfers the selected audio signal to the storage medium contemporaneously with the video signal being transferred by the video transfer mechanism. The user interface also includes audio source selector that allows the operator to determine which audio source is transferred to the storage medium.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of the video camera with an integrated radio receiver.

### DETAILED DESCRIPTION OF THE INVENTION

A video camera with an integral radio, or video camera, is shown and described at 100 in the figures. The video camera records video images on a desired recording medium contemporaneously with an audio track from a selected audio source. Various audio sources including a microphone, a radio receiver, and a line-in auxiliary input are available. With multiple audio sources available, a secondary audio program, such as a radio broadcast, can be recorded to narrate the video action.

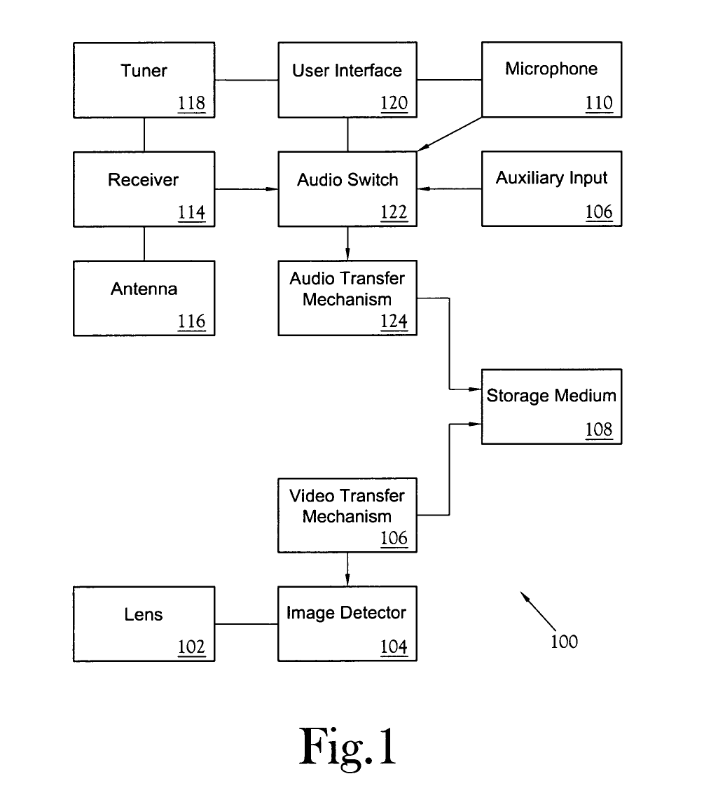

FIG. 1 is a block diagram of a video camera with an integral radio 100 according to the present invention. The video section of the video camera 100 includes a lens 102 that allows light carrying an image into the video camera 100. The light is collected by an image detector 104 that converts the light into a video signal. A video transfer mechanism 106 takes the video signal and transfers it onto a storage medium 108 for archival. Those skilled in the art will appreciate the various storage mediums that can be used with the present invention without departing from the scope and spirit of the present invention. Examples of suitable mediums include magnetic tapes for analog-based systems and hard drives or other magnetic media for digital-based systems. The mediums can be removable, for example tapes or discs, or remotely accessible through an external data port.

The audio section of the video camera 100 incorporates multiple audio sources. In the illustrated embodiment, a microphone 110 is used to pick up ambient sounds. An auxiliary input 112 provides an input for accepting a line level signal from a remote source, such as from a public address system. The video camera 100 also includes a radio receiver 114 for decoding radio frequency signals from a remote broadcast source. The radio frequency signals are received and transferred to the receiver through an antenna 116. A tuner 118 cooperating with the receiver 114 allows a particular radio frequency signal to be isolated for reception. A user interface 120 communicating with the tuner 118 includes a tuning selector that allows an operator to select a particular radio frequency or station for reception. In one embodiment, the tuning selector is implemented using buttons or a dial and digital display for the frequency. In another embodiment, tuning selector display is an analog display.

Each of the audio inputs, the microphone 110, the auxiliary input 112, and the radio receiver 114 are routed through a switch 122. The switch 122 controls which input is passed to an audio transfer mechanism 124. The audio transfer mechanism 124 transfers the selected audio signal to the storage medium 108 contemporaneously with the video signal being transferred by the video transfer mechanism 106. The user interface 120 also includes audio source selector that allows the operator to determine which audio source is transferred to the storage medium 108.

In one embodiment, the video camera has a simplified audio section including only the radio receiver and the associated components. In another embodiment, only the radio receiver and the microphone are implemented in the video camera.

Those skilled in the art will appreciate that the block diagram in FIG. 1 is not intended to show every component or interconnection of the electrical circuitry. Common interconnections such as power supply lines and routine circuitry associated with basic circuit design functions including regulation, trimming, and buffering have been omitted. The use and implementation of the omitted features is deemed to be within the purview of one skilled in the art.

A video camera with an integrated radio has been shown and described. The video camera includes a video section that records a video image on a storage medium. An audio section contemporaneously records an audio signal to the storage medium. The audio signal is selected from multiple sources including ambient sounds acquired through a microphone and a radio broadcast acquired through a radio receiver. An optional auxiliary input accepts an audio signal from a remote source.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An apparatus comprising:
a lens for receiving light;
an image detector in optical communication with said lens, said image detector sensitive to the light passing through said lens, said image detector producing a video image signal;
a video transfer mechanism in communication with said image detector, said video transfer mechanism transferring said visual image signal to a storage medium;
a microphone for detecting ambient sounds and producing a first audio signal;
an antenna sensitive to radio frequency signals;
a receiver in communication with said antenna and said tuning selector, said receiver for receiving the radio frequency signals at a frequency-of-interest and producing a second audio signal;
a tuner in communication with said user interface and said receiver, said tuner for isolating the radio frequency signals at said frequency-of-interest to provide said receiver with the radio frequency signals at said frequency-of-interest;
a user interface comprising a tuning selector for selecting said frequency-of-interest and an audio selector for selecting one of said microphone and said receiver as a selected input source, said user interface in communication with said audio switch and said tuner;
an audio switch comprising a first input, a second input, and an output, said microphone connected to said first input, said receiver connected to said second input, said audio switch connecting one of said first input and said second input corresponding to said selected input source with said output and passing a corresponding one of said first audio signal and said second audio signal as a selected audio signal;
an audio transfer mechanism in communication with said audio switch, said audio transfer mechanism transferring said selected audio signal to the storage medium contemporaneously with said video image signal; and
a user interface comprising a tuning selector for selecting said frequency-of-interest and an audio selector for selecting one of said plurality of inputs, said user interface in communication with said audio switch and said tuner.

2. The apparatus of claim 1 wherein said audio switch further comprises a third input, said apparatus further comprising an auxiliary input for accepting an input from a remote source as a third audio signal, said auxiliary input connected to audio switch third input, said audio switch connecting one of said first input, said second input, and said third input corresponding to said selected input source with said output and passing a corresponding one of said first audio signal, said second audio signal, and said third audio signal as a selected audio signal.
